(19) United States
(12) Patent Application Publication
(10) Pub. No.: US 2008/0296962 A1
(43) Pub. Date: Dec. 4, 2008

(54) Connection members of spokes for bicycle wheel

(76) Inventor: Rick Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,087

(22) Filed: May 30, 2007

(51) Int. Cl. B60B 1/00

(52) U.S. Cl. 301/104

(57) ABSTRACT

A spoke for bicycle wheel includes an elongate body and a first connection member and a second connection member are respectively connected to two ends of the elongate body so as to be connected to the hub and the rim of the bicycle wheel. Each of the first and second connection members has an enlarged end which is received in the elongate body to provide strong connection between the connection members and the spoke. The enlarged end can be an open or closed end which is a hollow or solid portion.

### FIELD OF THE INVENTION

The present invention relates to a airfoil shape spoke for bicycle wheel and two connection members on two ends of the spoke include an enlarged end securely received in the spoke.

### BACKGROUND OF THE INVENTION

A conventional bicycle wheel generally includes a rim with a hub located at a center of the rim, and a plurality of spokes are connected between the rim and the hub so as to maintain the shape of the rim by the tension of the spokes. The conventional spokes include a circular cross section which generates significant wind drag along with the speed of the bicycle. A latest bicycle spoke known to applicant is disclosed in U.S. Pat. No. 5,350,221 and the spokes disclosed are made by discontinuous fiber reinforced plastic which has strong structural strength and the direction of the fibers is the same as the longitudinal direction of the spokes so as to have higher rate of strength relative to weight. However, the disclosure does not provide detailed structure for the connection members on the two ends of each spoke.

The present invention intends to provide a spoke of bicycle wheel and two connection members are connected to two ends of the spoke, each connection member includes an enlarged end received in the spoke to provide a strong connection while the material of the connection members is the least.

### SUMMARY OF THE INVENTION

The present invention relates to a spoke for bicycle wheel and the spoke is an elongate body made by compound material and includes a first connection member on a first end of the spoke and a second connection member on a second end of the spoke. The first connection member is made by metallic material and has a first enlarged end at a first end thereof and the first enlarged end is received in the first end of the elongate body. A second end of the first connection member is connected with a hub. The second connection member is made by metallic material and connected to the second end of the elongate body. The second connection member has a second enlarged end at a first end thereof and the second enlarged end is received in the second end of the elongate body. A second end of the second connection member is connected with a rim.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a bicycle wheel with spokes of the present invention;

FIG. 2 is a cross sectional view to show the spoke and the connection members of the present invention;

FIG. 3 is a cross sectional view to show the spoke and a second embodiment of the connection members of the present invention;

FIGS. 4a, 4b and 4c show a third embodiment of the connection members of the present invention in different shapes;

FIGS. 5a, 5b and 5c show a fourth embodiment of the connection members of the present invention in different shapes;

FIGS. 6a, 6b and 6c show a fifth embodiment of the connection members of the present invention in different shapes;

FIGS. 7a, 7b, 7c and 7d show a sixth embodiment of the connection members of the present invention, and

FIG. 8 shows that a second embodiment of the spokes of the present invention.

### DETAILED DESCRIPTION OF THE PREFERRED EMBODIMENT

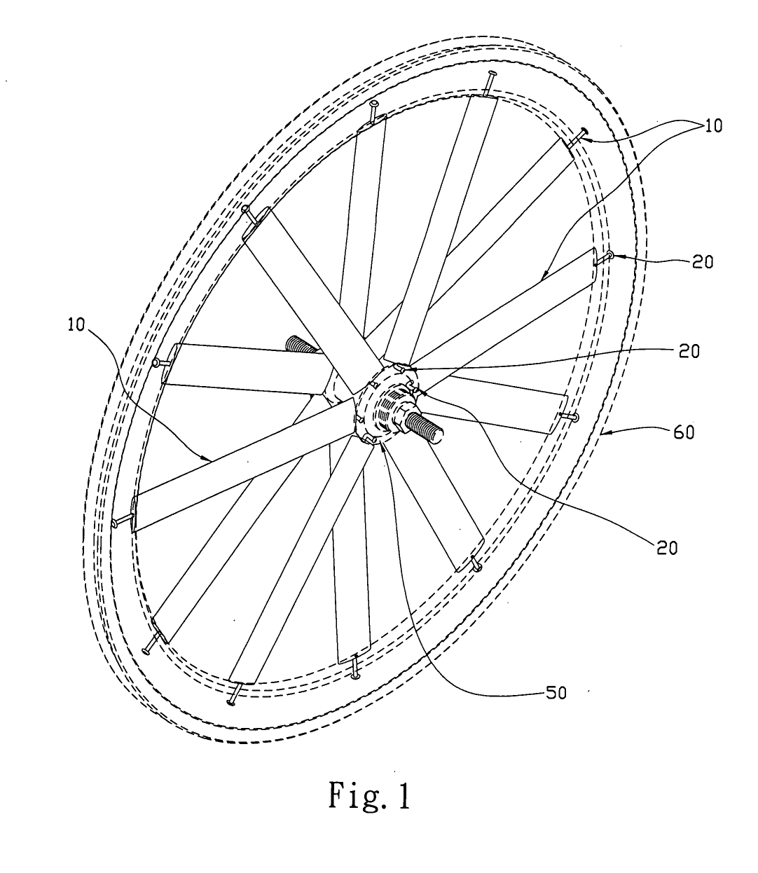

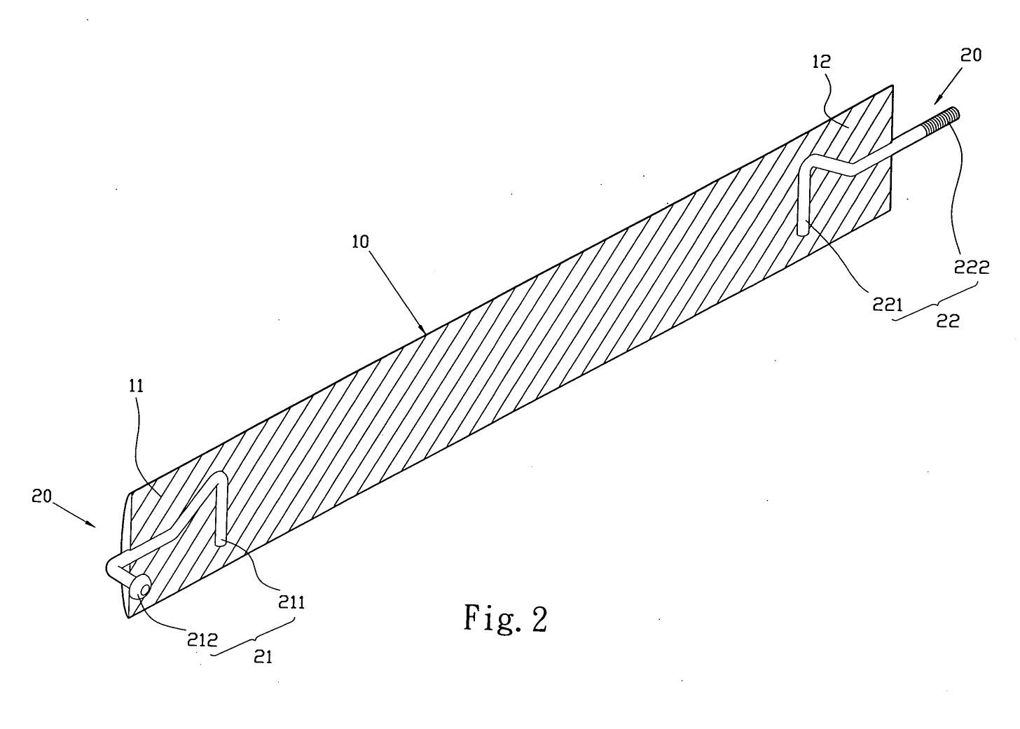

Referring to FIGS. 1 and 2, the bicycle wheel to be connected with the spokes of the present invention comprises a rim 60 and a hub 50 is located at a center of the rim 60, the spokes are connected between the hub 50 and the rim 60 by two connection units 20. Each spoke includes an elongate body 10 made by compound material and the elongate body 10 has an airfoil shape cross section. A first connection member 21 made by metallic material is connected to a first end of the elongate body 10 and includes a first enlarged end 211 at a first end thereof. The first enlarged end 211 means a width of the first enlarged end 211 is wider than the rest portion of the first connection member 21. The first enlarged end 211 is received in the first end 11 of the elongate body 10 and a second end of the first connection member 21 includes a bend and a nub 212 is connected to a distal end of the bend. The bend is hooked to the hub 50.

A second connection member 22 is made by metallic material and connected to a second end 12 of the elongate body 10. The second connection member 22 has a second enlarged end 221 at a first end thereof and the second enlarged end 221 is received in the second end 12 of the elongate body 10. A second end of the second connection member 22 includes a threaded section 222 which is connected with the rim 60. The elongate body can be made by carbon fibers, glass fibers, fiber reinforced plastic or any known compound material.

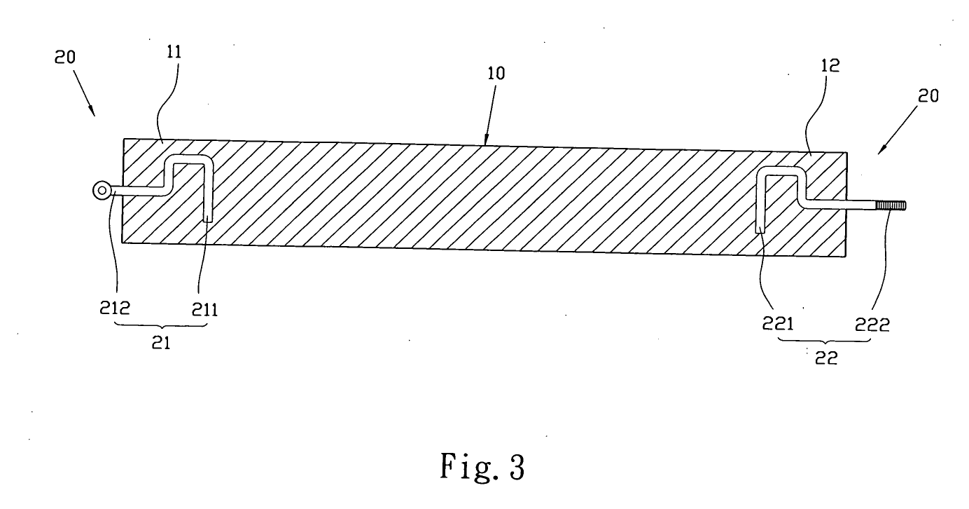

Each of the first and second enlarged ends 211, 221 includes an opened bent section so as to be connected with the elongate body 10 by wider area. The opened bent section can be substantially V-shaped as shown in FIG. 2 or U-shaped as shown in FIG. 3.

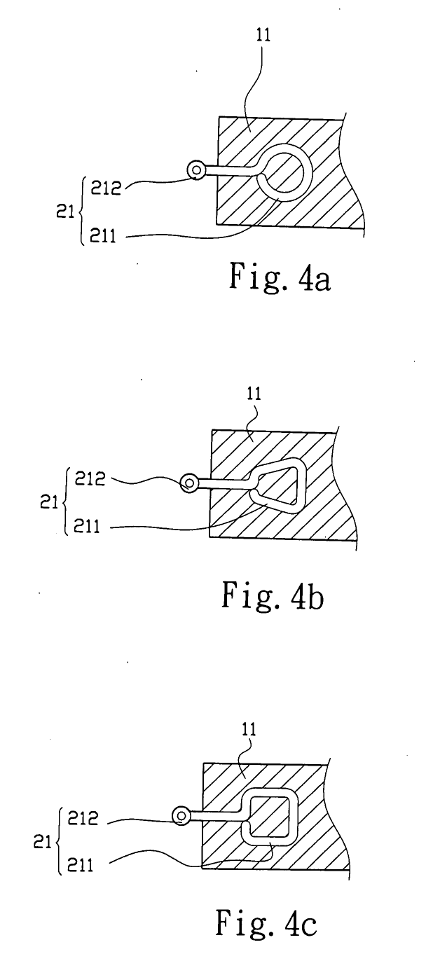

FIGS. 4a, 4b, 4c show that first enlarged end 211 of the first connection member 21 can be formed in different shapes such as a circle, a pentagon, and a square, and a distal end of the first end is bent and in contact with the first/second connection member 21/22.

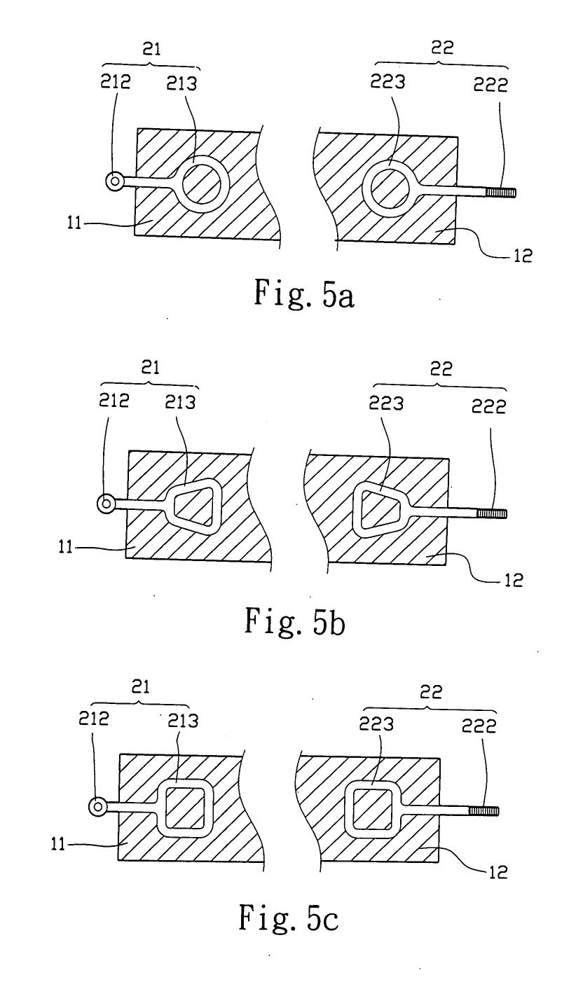

FIGS. 5a, 5b, 5c show that each of the first and second enlarged ends 213, 223 can be a hollow and closed portion in different shapes such as a circle, a pentagon, and a square.

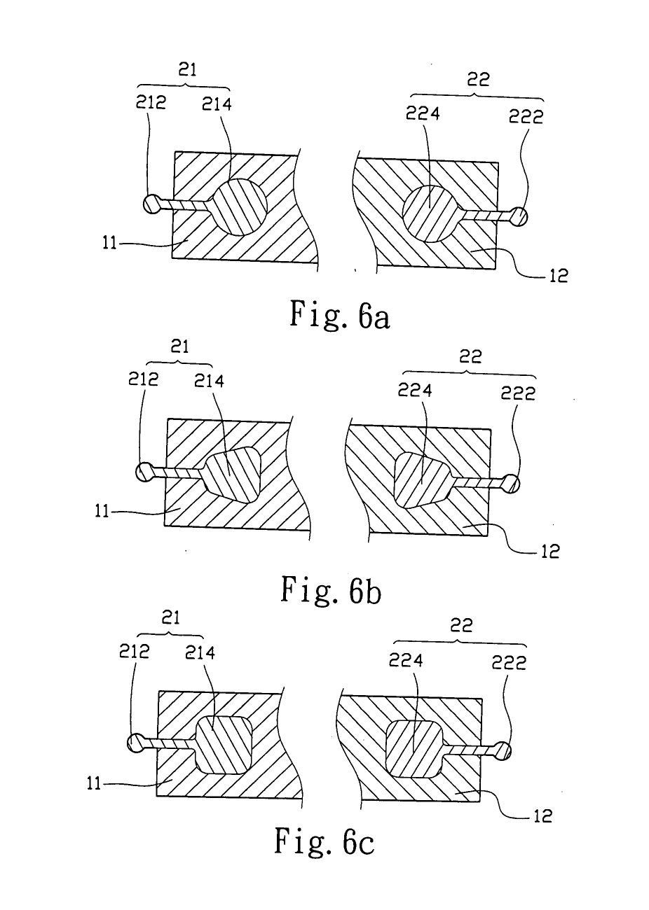

FIGS. 6a, 6b and 6c show that each of the first and second enlarged ends 214, 224 is a solid end in different shapes such as a circle, a pentagon, and a square.

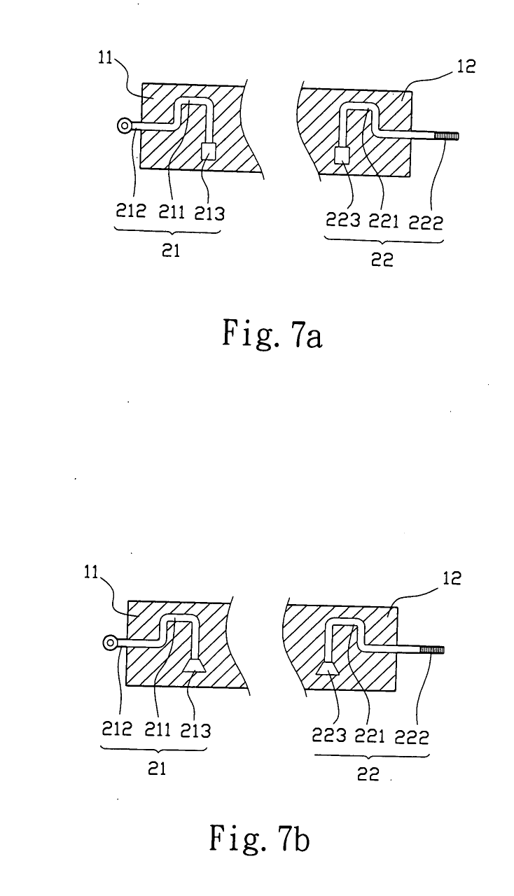

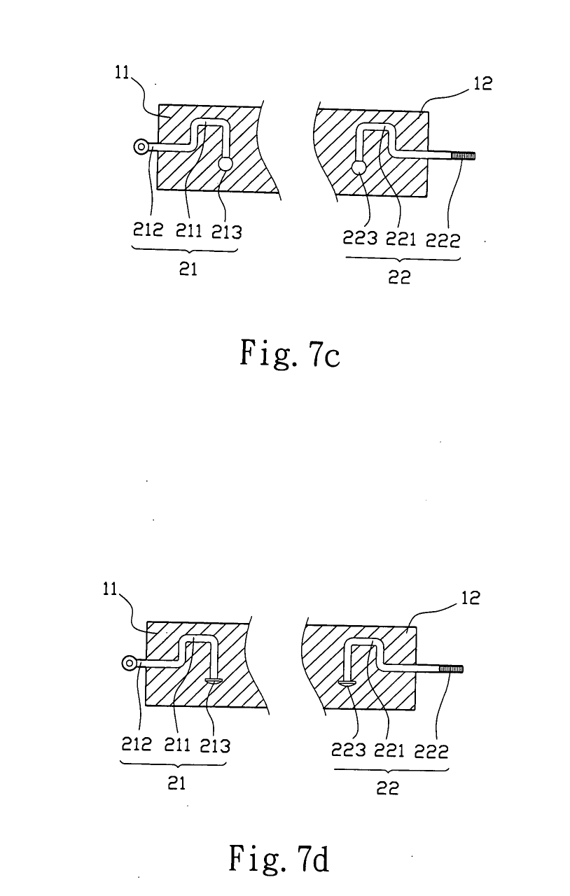

FIGS. 7a, 7b, 7c and 7d show that each of the opened bent section of the first and second enlarged ends 211, 221 includes a nub 213/223 connected to a distal end thereof and the nub 213, 223 are received in the elongate body 10.

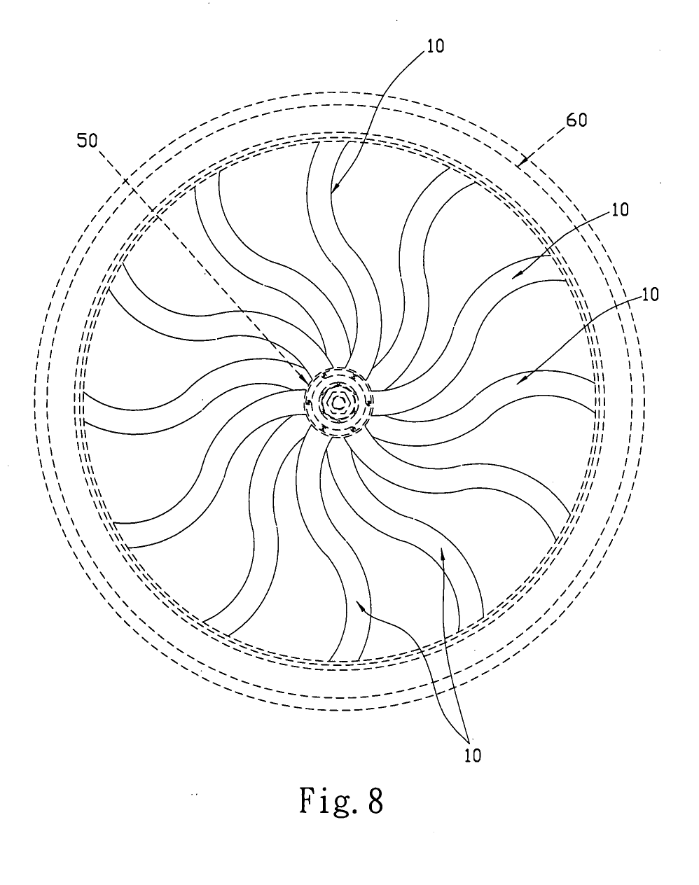

By the different embodiment of the first and second connection members 21, 22, the connection between the first and second connection members 21, 22 and the elongate body 10 is strong and the material and weight for the first and second connection members 21, 22 are least. FIG. 8 shows that the spokes can be made to be S-shaped

While we have shown and described the embodiment in accordance with the present invention, it should be clear to those skilled in the art that further embodiments may be made without departing from the scope of the present invention.

What is claimed is:

1. A spoke for bicycle wheel, comprising:
an elongate body made by compound material and including a first end and a second end, and
a first connection member made by metallic material and connected to the first end of the elongate body, the first connection member having a first enlarged end at a first end thereof and the first enlarged end being received in the first end of the elongate body, a second end of the first connection member adapted to be connected with a hub, and
a second connection member made by metallic material and connected to the second end of the elongate body, the second connection member having a second enlarged end at a first end thereof and the second enlarged end being received in the second end of the elongate body, a second end of the second connection member adapted to be connected with a rim.

2. The spoke as claimed in claim 1, wherein each of the first and second enlarged ends includes an opened bent section.

3. The spoke as claimed in claim 2, wherein each of the opened bent section of the first and second enlarged ends includes a nub connected to a distal end thereof.

4. The spoke as claimed in claim 1, wherein each of the first and second enlarged ends includes a hollow and closed portion.

5. The spoke as claimed in claim 1, wherein each of the first and second enlarged ends is in a form of a bent section and a distal end of the first end is in contact with the first/second connection member.

6. The spoke as claimed in claim 1, wherein each of the first and second enlarged ends is a solid end.

7. The spoke as claimed in claim 1, wherein the elongate body is made by carbon fibers.

8. The spoke as claimed in claim 1, wherein the second end of the first connection member includes a bend and a nub is connected to a distal end of the bend.

9. The spoke as claimed in claim 1, wherein the second end of the second connection member includes a threaded section.
